(19) United States
(12) Patent Application Publication
(10) Pub. No.: US 2024/0253565 A1
(43) Pub. Date: Aug. 1, 2024

(54) IMAGE PROCESSING SYSTEM, MOVABLE APPARATUS, IMAGE PROCESSING METHOD, AND STORAGE MEDIUM

(71) Applicant: CANON KABUSHIKI KAISHA, Tokyo (JP)

(72) Inventor: RYO FUEDA, Tokyo (JP)

(21) Appl. No.: 18/417,140

(22) Filed: Jan. 19, 2024

(30) Foreign Application Priority Data
Jan. 26, 2023 (JP) 2023-009994

(51) Int. Cl. B60R 1/25; H04N 5/262; H04N 7/18; H04N 23/698

(52) U.S. Cl. CPC B60R 1/25; H04N 5/2624; H04N 5/2628; H04N 7/181; H04N 23/698; B60R 2300/105; B60R 2300/30

(57) ABSTRACT

An image acquisition unit configured to acquire video image data of a front video image captured in front of a movable apparatus and a rear video image captured in rear of the movable apparatus, and a display unit configured to display a video image on a right side or a left side of the movable apparatus are provided, the display unit has a rear display region in which the rear video image is displayed and a second display region in which second information is displayed, and, in a case in which the front video image is displayed in the second display region, the rear video image is displayed in the rear display region without inverting the rear video image, and, in a case in which the front video image is not displayed in the second display region, the rear video image is inverted and displayed in the rear display region.

### CROSS-REFERENCE TO PRIORITY APPLICATION

This application claims the benefit of Japanese Patent Application No. 2023-009994, filed on Jan. 26, 2023, which is hereby incorporated by reference herein in its entirety.

### BACKGROUND OF THE INVENTION

### Field of the Invention

The present invention relates to an image processing system, a movable apparatus, an image processing method, a storage medium, and the like.

### Description of the Related Art

The area around the tires in front of a vehicle is a blind spot that cannot be directly viewed from a driver's seat. In order to prevent accidents caused by not noticing an object in the blind spot in front of the vehicle during starting or parking, some vehicles are equipped with two or more mirrors so that both the front and rear of the vehicle can be seen.

In addition to a side-view mirror for viewing the rear side of the vehicle For example, some trucks are provided with a side-under mirror for viewing the periphery of tires in front of the vehicle. Additionally, in recent years, there is a demand for replacing the mirror mounted on the vehicle with a camera and a monitor, and there is also a vehicle having a monitor mounted in which a plurality of regions (display regions) for displaying an image are arranged.

For example, Japanese Patent Application Laid-Open No. 2006-50246 discloses a system in which a fish-eye camera is mounted on a side surface of a vehicle, and thereby, a video image is captured from the front to the rear of the vehicle with one camera, and a video image of the front side of the vehicle (front video image) and a video image of the rear side of the vehicle (rear video image) are switched and displayed on a monitor.

However, in Japanese Patent Application Laid-Open No. 2006-50246, the rear video image used as a video image for an electronic side mirror is inverted and displayed. Consequently, in a case in which the front video image and the rear video image are displayed side by side in the two display regions, it is difficult for a user to grasp the correlation between the video images, which causes confusion.

### SUMMARY OF THE INVENTION

An image processing system according to one aspect of the present invention comprising: at least one processor or circuit configured to function as: an image acquisition unit configured to acquire video image data of a front video image captured in front of a movable apparatus and a rear video image captured in rear of the movable apparatus; and a display unit configured to display a video image on a right side or a left side of the movable apparatus, wherein the display unit displays the rear video image in a rear display region and displays second information in a second display region, and wherein in a case in which the front video image is displayed in the second display region, the rear video image is displayed in the rear display region without inverting the rear video image, and in a case in which the front video image is not displayed in the second display region, the rear video image is inverted and displayed in the rear display region.

Further features of the present invention will become apparent from the following description of embodiments with reference to the attached drawings.

### BRIEF DESCRIPTION OF THE DRAWINGS

FIG. 1 is a functional block diagram illustrating a configuration example of an image processing system in the first embodiment.

FIG. 2 is a diagram for explaining an example of a video image formed in the first embodiment.

FIG. 3 is a diagram for explaining a continuation of FIG. 2.

FIGS. 4A and 4B are diagrams for explaining a display example of a display unit 300 in the first embodiment.

FIG. 5 is a flowchart for explaining an operation example in which an integration processing unit 200 outputs a rear video image to the display unit 300.

FIG. 6 is a flowchart that explains an operation example in which the integration processing unit 200 outputs a second video image to the display unit 300.

FIG. 7 is a functional block diagram showing a configuration example of an image processing system 1000′ in the second embodiment.

FIG. 8 is a diagram for explaining an example of a video image formed in the second embodiment.

FIG. 9 is a diagram for explaining a continuation of FIG. 8.

FIG. 10 is a diagram for explaining a continuation of FIG. 9.

FIGS. 11A and 11B are diagrams for explaining a display example of the display unit 300 in the second embodiment.

FIG. 12 is a flowchart for explaining an operation example in which the integration processing unit 200 outputs a rear video image to the display unit 300 in the second embodiment.

FIG. 13 is a flowchart for explaining an operation example in which the integration processing unit 200 outputs the second video image to the display unit 300 in the second embodiment.

FIG. 14 is a functional block diagram showing a configuration example of an image processing system of the third embodiment.

FIGS. 15A and 15B are diagrams for explaining a display example of the display unit 300 in the third embodiment.

FIGS. 16A and 16B are diagrams for explaining optical characteristics of wide angle lenses 111a and 111b serving as optical systems according to the fourth embodiment.

### DESCRIPTION OF THE EMBODIMENTS

Hereafter, with reference to the accompanying drawings, favorable modes of the present invention will be described using Embodiments. In each diagram, the same reference signs are applied to the same members or elements, and duplicate description will be omitted or simplified.

### First Embodiment

In the first embodiment, a method for displaying a front video image on a monitor having two display regions that are adjacent to each other in the horizontal direction, and thereby, a user can grasp the correlation between the front video image and a rear video image will be explained.

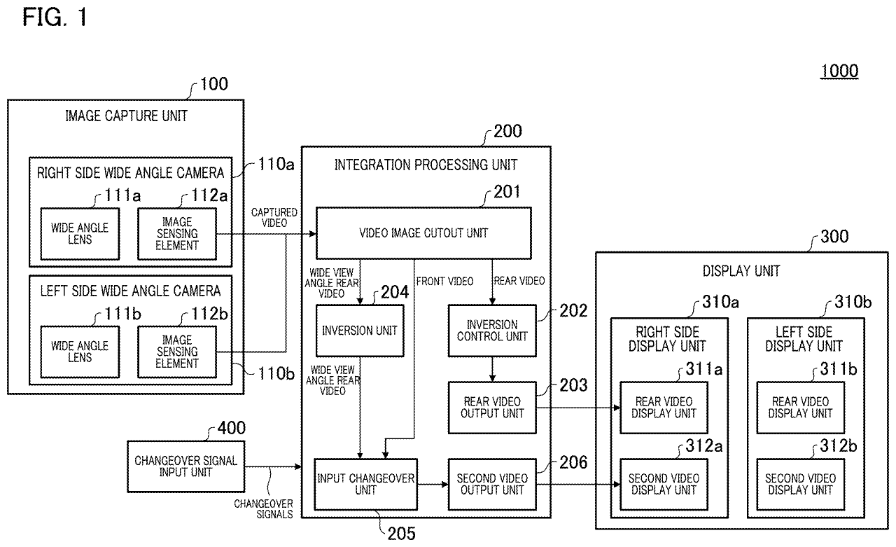

FIG. 1 is a functional block diagram illustrating a configuration example of an image processing system 1000 in the first embodiment. Note that some of the functional blocks as shown in FIG. 1 are realized by causing a CPU and the like serving as a computer (not illustrated) included in the integration processing unit 200 of the image processing system 1000 to execute a computer program stored in a memory serving as a storage medium (not illustrated).

However, some or all of them may be realized by hardware. As the hardware, a dedicated circuit (ASIC), a processor (reconfigurable processor, DSP), and the like can be used.

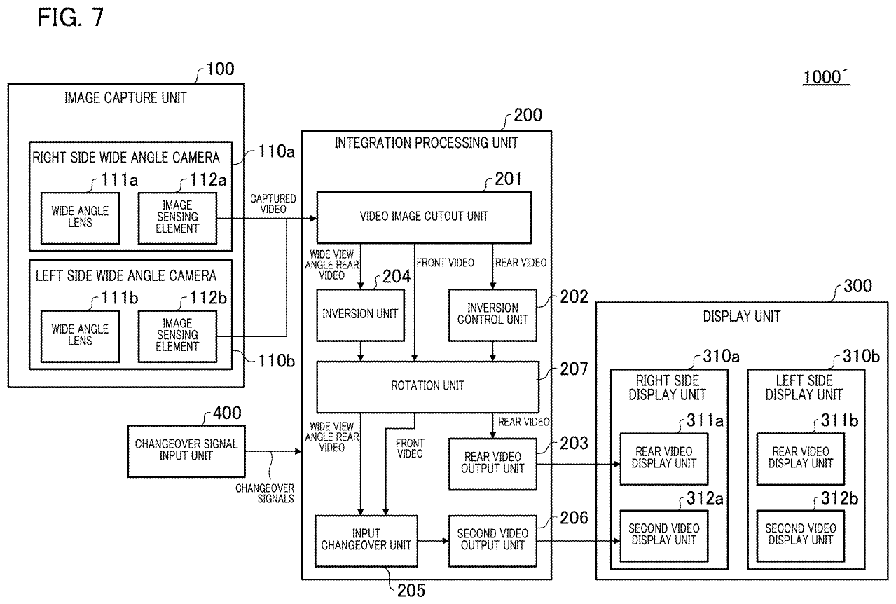

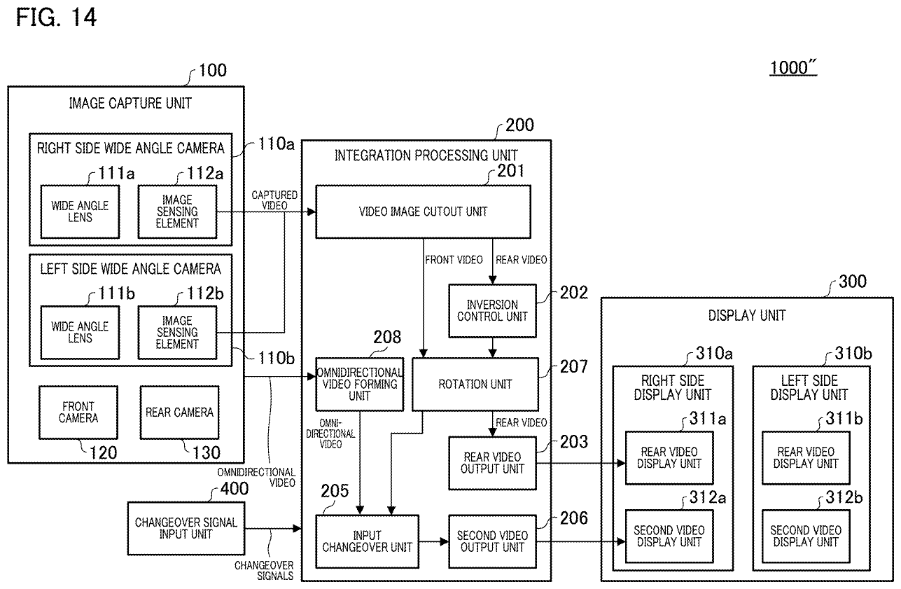

Additionally, each of functional blocks as shown in FIG. 1 may not necessarily be incorporated in the same housing and may be configured by separate devices connected to each other via a signal path. Note that the above explanation regarding FIG. 1 also applies to FIG. 7 and FIG. 14.

The image processing system 1000 has image capture units 100, the integration processing unit 200, display units 300, and a changeover signal input unit 400. The image capture unit 100 includes, for example, a plurality of in-vehicle cameras that capture images of the surroundings of a vehicle such as an automobile serving as a movable apparatus.

The display units 300 are, for example, monitors that are respectively mounted on the right front side and the left front side of the driver's seat, and each monitor has, for example, two display regions adjacent to each other in the horizontal direction. Note that each monitor may be configured to be able to display one screen by dividing the screen into two display regions, or each monitor may be configured by arranging two display devices side by side. The changeover signal input unit 400 is, for example, a push button mounted on a steering wheel.

The image capture unit 100 has a right-side wide view camera 110a and a left-side wide angle camera 110b. The right-side wide view camera 110a is attached to the right side of the vehicle and can capture an image from the front to the rear of the vehicle by approximately 180°. The left-side wide angle camera 110b is attached to the left side of the vehicle and is capable of capturing an image from the front to the rear of the automobile approximately 180°.

The right-side wide angle camera 110a and the left-side wide angle camera 110b have wide angle lenses 111a and 111b serving as optical systems capable of capturing images from the front to the rear of the side surface of the vehicle by 180°. Additionally, they respectively have image sensing elements 112a and 112b such as a CMOS image sensor and a CCD image sensor. Thus, the image capture unit 100 captures a wide angle video image using an optical system capable of capturing an image of a side surface of a movable apparatus from the front to the rear and generates video image data.

The wide angle lenses 111a and 111b serving as the optical systems may be typical wide angle lenses, or may have optical characteristics in which the resolutions of the peripheral portions of the angles of view are relatively higher than those of the central portions of the angles of view, as will be described below.

Note that, in the first embodiment, it is desirable that the right-side wide angle camera 111a and the left-side wide angle camera 111b are mounted in the vehicle in such a manner that the optical axes of the wide angle lenses 110a and 110b are substantially horizontal (or substantially parallel to the ground) when the vehicle serving as a movable apparatus is in a horizontal state. That is, when the rear display region and a second display region are arranged side by side, it is desirable that the optical axes of the optical system are arranged in the horizontal direction.

Each of the image sensing elements 112a and 112b is configured by a plurality of pixels, and a color filter of any one of R, G, and B is disposed in each pixel in, for example, a Bayer array. Additionally, each of the image sensing elements 112a and 112b of the image capture unit 100 captures an optical image, generates a captured image signal, and outputs a captured video image (video image data) obtained by RAW development of the image pickup signals by an image processing unit (not illustrated) to the integration processing unit 200.

Specifically, the image capture unit 100 has an image processing unit (not illustrated), the image processing unit performs de-Bayer processing on the image capturing signals that have been input from the image sensing elements 112a and 112b according to the Bayer array, and converts them into video image data in a RGB raster format.

Further, the image processing unit performs various kinds of correction processing such as white balance adjustment, gain/offset adjustment, gamma processing, color matrix processing, and reversible compression processing. However, lossy compression processing or the like is not performed, and what is referred to as an RGB image obtained by RAW development is formed. Note that the image processing unit may have a distortion correction function.

The integration processing unit 200 has a video image cutout unit 201, an inversion control unit 202, a rear video image output unit 203, an inversion unit 204, an input changeover unit 205, and a second video image output unit 206. Additionally, the integration processing unit 200 has a CPU serving as a computer (not illustrated) that controls each of the units 201 to 206, and a program memory that stores a computer program.

The video image cutout unit 201 cuts out a rear video image and a front video image from the video image data acquired from the image capture unit 100. Note that, at this time, the video image cutout unit 201 cuts out a wide view angle rear video image having a wider angle of view than the rear video image of the vehicle from the video image data. Additionally, the video image cutout unit 201 outputs the rear video to the inversion control unit 202, outputs the wide view angle rear video to the inversion unit 204, and outputs the front video to the input changeover unit 205.

Here, in a case in which the rear video image is cut out, an end portion (for example, a part of a rear bumper) on the rear side of the vehicle body is included in the rear video image. That is, in a case in which the rear video image is cut out from the video image data, the cutout is performed such that the end portion on the rear side of the movable apparatus is included.

Additionally, in a case in which the front video image is cut out, an end portion (for example, a part of a front bumper) on the front side of the vehicle is included in the front video image. That is, in a case in which the front video image is cut out from the video image data, the cutout is performed such that the end portion on the front side of the movable apparatus is included.

As described above, the end portion on the rear side, for example, the rear bumper is included in the rear video image, and the end portion on the front side, for example, the front bumper is included in the front video image, and, as a result, when the rear video image and the front video image are displayed at the same time, the user can visually recognize both side ends of the vehicle. Therefore, the positional relation between the objects in the front video image and the rear video image can be easily identified.

The inversion control unit 202 controls the inversion/non-inversion of the rear video image based on the input of the changeover signal from the changeover signal input unit 400, and limits the rear video image to be non-inverted when the changeover signal indicating the non-inversion is input.

Specifically, when the input of the changeover signal is Low, the inversion control unit 202 inverts the rear video image that has been input from the video image cutout unit 201 in a left and right direction to form an inverted rear video image, and when the input of the changeover signal is High, the inversion control unit 202 does not invert the rear video image that has been input from the video image cutout unit 201 in the left and right direction. Additionally, the inversion control unit 202 outputs the inverted/non-inverted rear video image to the rear video image output unit 203.

As described above, the inversion/non-inversion of the rear video image is controlled based on the input of the changeover signal, and consequently, the rear video image is not inverted while the changeover signal is High, and the correlation between the front video image and the rear video image can be maintained.

The rear video image output unit 203 converts the resolution of the rear video image that has been input from the inversion control unit 202 and outputs the rear video image to the display unit 300. The inversion unit 204 inverts the wide view angle rear video image that has been input from the video image cutout unit 201 in the right and left direction to form an inverted wide view angle rear video, and outputs the inverted wide view angle rear video image to the input changeover unit 205.

The input changeover unit 205 changes over the video image to be output to the second video output unit 206 based on the input of the changeover signal from the changeover signal input unit 400. Specifically, when the input of the changeover signal is Low, the input changeover unit 205 outputs the wide view angle rear video image that has been input from the inversion unit 204 to the second video image output unit 206, and when the input of the changeover signal is High, the input changeover unit 205 outputs the front video that has been input from the video image cutout unit 201 to the second video image output unit 206.

As described above, the front video and the non-inverted rear video image can be output to the display unit 300 while the changeover signal is High by switching between the case in which the front video is not displayed on the display unit 300 and the case in which the front video is displayed on the display unit 300, in conjunction with the operation of the inversion control unit 202 based on the input of the changeover signal.

The second video image output unit 206 converts the resolution of the wide view angle rear video image or the front video image that has been input from the input changeover unit 205, and outputs the converted video image to the display unit 300 as the second video image.

The display unit 300 simultaneously performs the display of the rear video image as the camera monitor system for the electronic side mirror and the display of the second video image as the information for assisting the driving. Specifically, the display unit 300 has a right-side display unit 310a that is mounted on the right front side of the driver's seat and displays the video image of the right side of the vehicle, and a left-side display unit 310b that is mounted on the left front side of the driver's seat and displays the video image of the left side of the vehicle. That is, the display unit 300 displays a video image on the right side or the left side of the movable apparatus.

The right-side display unit 310a has a rear video image display unit 311a and a second video image display unit 312a, and the left-side display unit 310b has a rear video image display unit 311b and a second video image display unit 312b.

The rear video image display units 311a and 311b display the rear video image that has been input from the rear video image output unit 203. Additionally, the second video image display units 312a and 312b display the second video image that has been input from the second video image output unit 206.

The changeover signal input unit 400 is, for example, a momentary push button and the like mounted on a steering wheel, and the state of the changeover signal is switched to, for example, High when the button is pressed by the user, and the state of the changeover signal is switched to Low when the button is not pressed.

Accordingly, a changeover signal of either High or Low is output to the integration processing unit 200. Here, High of the changeover signal means that the front video image is displayed on the display unit 300, and Low of the changeover signal means that the front video image is not displayed on the display unit 300.

For example, when the push button is pressed by the user, the front video image and the non-inverted rear video image are simultaneously displayed on the display unit 300, and when the push button is not pressed, the wide view angle rear video image and the inverted rear video image are simultaneously displayed on the display unit 300.

Note that although, in the first embodiment, the changeover signal input unit 400 is configured by a momentary type push button, the changeover signal may be formed based on a variety of information indicating the state of the vehicle by detecting a variety of information indicating the state of the vehicle such as a vehicle speed, a direction indicator, and a shift lever. Additionally, a variety of information around the vehicle such as an intersection and an obstacle may be detected to form the changeover signal based on the variety of information around the vehicle.

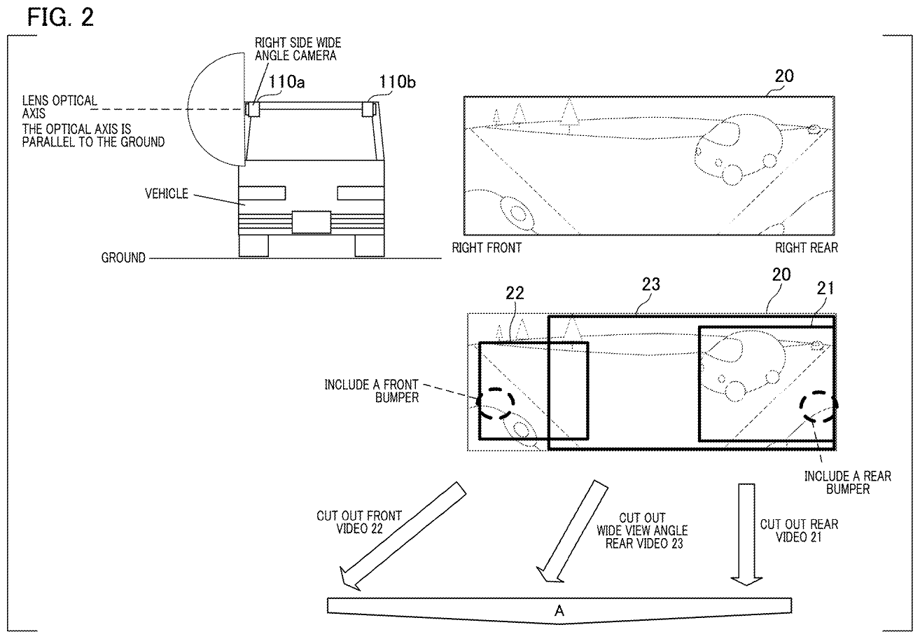

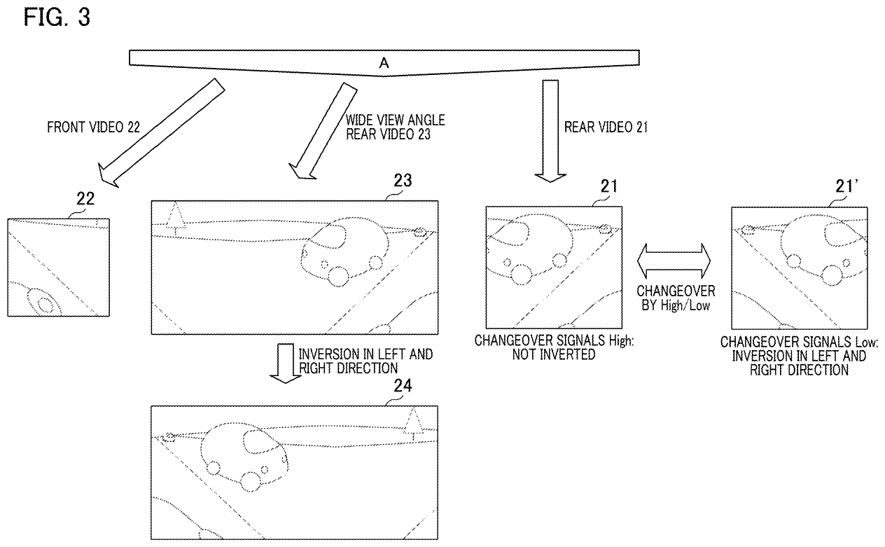

An operation example of the entire integration processing unit 200 in the first embodiment will be explained with reference to FIG. 2 and FIG. 3. FIG. 2 is a diagram for explaining an example of a video image formed in the first embodiment, and FIG. 3 is a diagram for explaining a continuation of FIG. 2.

As shown in FIG. 2, the integration processing unit 200 cuts out a rear video image 21, a front video image 22, and a wide view angle rear video image 23, which will be described below, from the video image 20 that has been input from the right-side wide angle camera 110a.

Further, as shown in FIG. 3, a wide view angle rear video image 24 that is inverted in the left and right direction is formed from the wide view angle rear video image 23. Additionally, when the changeover signal is High, the integration processing unit 200 outputs the rear video image 21 that is not inverted and the front video image 22, and when the changeover signal is Low, the integration processing unit 200 outputs the rear video image 21′ and the wide view angle rear video image 24, which are inverted, to the display unit 300.

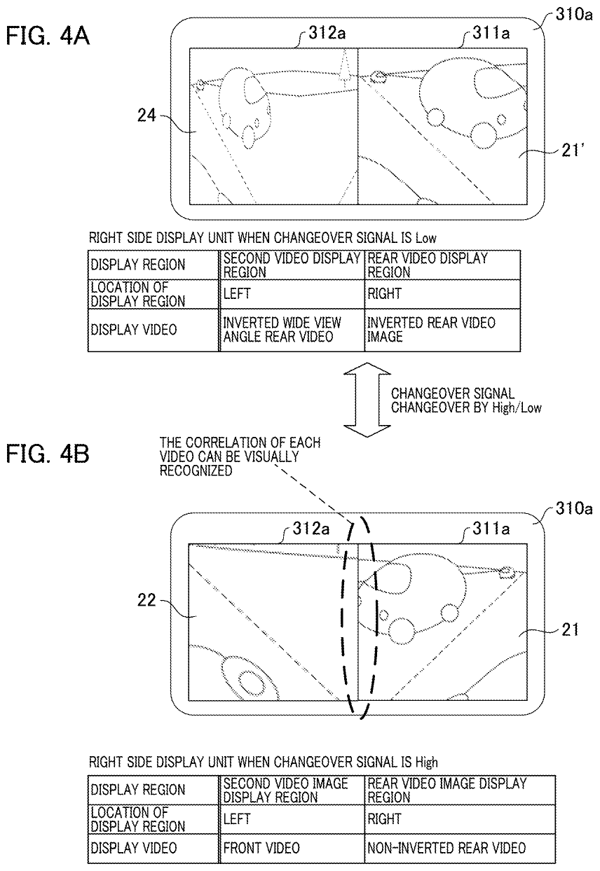

FIGS. 4A and 4B are diagrams for explaining a display example of the display unit 300 in the first embodiment, and, in particular, show a display example in the right-side display unit 310a. The rear video image display unit 311a and the second video display unit 312a of the right-side display unit 310a are disposed to be adjacent to each other in the horizontal direction as shown in FIG. 3. Note that although not illustrated, the rear video display unit 311b and the second video display unit 312b of the left display unit 310b are similarly arranged so as to be adjacent to each other in the lateral direction.

Note that the rear video image display unit 311a is set such that the right side of the display screen of the right-side display unit 310a is the rear video image display region (rear display region), and the second video image display unit 312a is set such that the left side of the display screen of the right-side display unit 310a is the second video image display region (second display region).

In contrast, the rear video image display unit 311b is set such that the left side of the display screen of the left-side display unit 310b is the rear video image display region (rear display region), and the second video image display unit 312b is set such that the right side of the display screen of the left-side display unit 310b is the second video image display region (second display region).

Thus, the display unit 300 has the rear display region in which the rear video image is displayed and the second display region in which the second information is displayed. Additionally, the rear display region and the second display region are arranged vertically or horizontally.

Additionally, video images displayed on the right-side display unit 310a are changed over based on the input of the changeover signals to the integration processing unit 200. That is, as shown in FIG. 4A, in a case in which the changeover signal is Low, the wide view angle rear video image 24 that is inverted in a right and left direction and the rear video image 21′ that is inverted in a right and left direction are simultaneously displayed on the right and left sides of the right-side display unit 310a.

In contrast, as shown in FIG. 4B, when the changeover signal is High, the front video image 22 and the rear video image 21 that is not inverted are simultaneously displayed on the right and left sides of the right-side display unit 310a. Note that although not illustrated, the same applies to the left-side display unit 310b.

Thus, in the case in which the front video image 22 is displayed in the second display region, the rear video image 21 that is not inverted is displayed in the rear display region, and, in the case in which the front video image 22 is not displayed in the second display region, the rear video image 21 is inverted and displayed in the rear display region. Additionally, the rear display region and the second display region are arranged in a such a manner that, when the front video image is displayed in the second display region, the sides having a correlation between the front video image and the rear video image are adjacent to each other.

That is, as shown in FIG. 4B, when the changeover signal is High, the sides having a correlation between the front video image and the rear video image are displayed to face each other, and thereby, the user can visually recognize the correlation between the front video image and the rear video image.

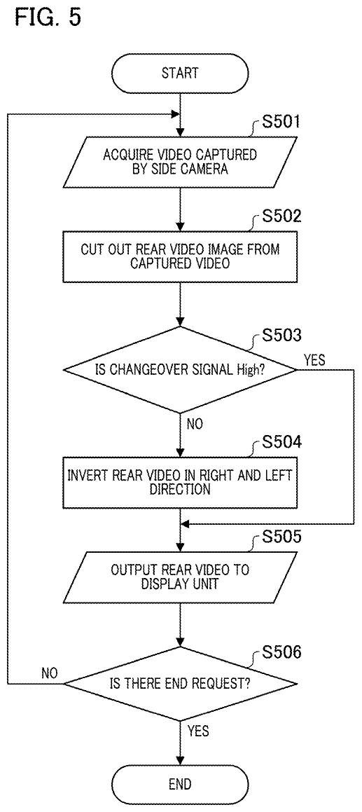

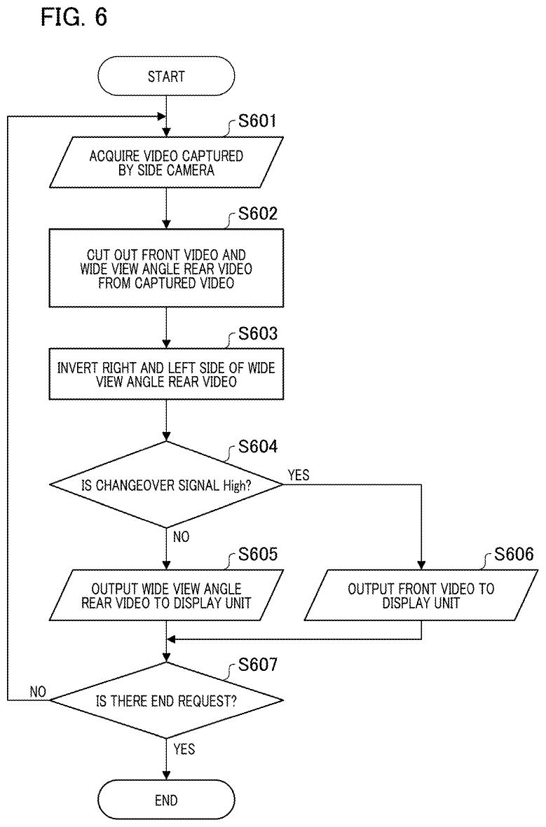

FIG. 5 is a flowchart that explains an operation example in which the integration processing unit 200 outputs the rear video image to the display unit 300, and FIG. 6 is a flowchart that explains an operation example in which the integration processing unit 200 outputs the second video image to the display unit 300. The process of each step in the flowcharts of FIG. 5 and FIG. 6 is sequentially performed by a CPU (not illustrated) of the integration processing unit 200 executing a computer program.

In step S501, the CPU of the integration processing unit 200 acquires, from the image capture unit 100, which is a side camera, video image data that are a captured video image obtained by capturing images from the front to the rear of the side surfaces of the vehicle at wide angles, and the videos image data are input to the video image cutout unit 201.

Here, step S501 functions as a video image acquiring step (video image acquiring unit) of acquiring video image data of a front video image captured in front of the movable apparatus and a rear video image captured in rear of the movable apparatus. Subsequently, the process of step S502 is executed.

In step S502, the CPU of the integration processing unit 200 cuts out the rear video image from the video image data that are the captured video images. Here, the rear video image is cut out to include, for example, a portion of the rear bumper that is the end portion on the rear side of the vehicle. Thereafter, the cut-out rear video image is input to the inversion control unit 202. Subsequently, the process of step S503 is executed.

In step S503, the CPU of the integration processing unit 200 determines whether the changeover signal input from the changeover signal input unit 400 is High or Low. When the determination result is Low (NO), the process proceeds to step S504, and when the determination result is High (YES), the rear video image is input to the rear video image output unit 203, and then the process of step S505 is executed.

In step S504, the CUP of the integration processing unit 200 inverts the right and left of the rear video image. Subsequently, the inverted rear video image is input to the rear video image output unit 203. Subsequently, the process of step S505 is executed.

In step S505, the CPU of the integration processing unit 200 outputs a non-inverted rear video image on which step S504 has not been executed or an inverted rear video image on which step S504 has been executed, to the display unit 300. Here, step S505 functions as a display step of displaying a video image on the right side or the left side of the movable apparatus. Subsequently, the process of step S506 is executed.

In step S506, the CUP of the integration processing unit 200 determines whether or not there is an end request from the user. When the determination result is “NO”, the process proceeds to step S501, and when the determination result is “YES”, the process ends.

Note that, for the end request from the user, “YES” is determined, for example, in a case in which when the integration processing unit 200 detects the engine OFF in a state in which the engine ON/OFF of the vehicle is input to the integration processing unit 200.

In step S601, the CPU of the integration processing unit 200 acquires video image data that are captured images captured at a wide angle from the front to the rear of the side surface of the vehicle, from the image capture unit 100, which is a side camera. Here, the video image data are input to the video image cutout unit 201. Subsequently, the process of step S602 is executed.

In step S602, the CPU of the integration processing unit 200 cuts out a front video image and a wide view angle rear video image from the captured video image (video data). Here, the front video image is cut out so as to include, for example, a portion of a front bumper that is an end portion on the front side of the vehicle, and the wide view angle rear video image is cut out so as to have a wider view angle than the rear video image in the rear of the vehicle.

Subsequently, the front video image is input to the input changeover unit 205, and the wide view angle rear video image is input to the inversion control unit 202. Subsequently, the process of step S603 is executed.

In step S603, the CPU of the integration processing unit 200 inverts the right and left of the wide view angle rear video image. Subsequently, the inverted wide view angle rear video image is input to the input changeover unit 205. Thereafter, the process of step S604 is executed.

In step S604, the CPU of the integration processing unit 200 determines whether the changeover signal input from the changeover signal input unit 400 is High or Low. When the determination result is Low (NO), the inverted wide view angle rear image is input to the second video image output unit 206, and then the process in step S605 is executed. When the determination result is High (YES), the front image is input to the second video image output unit 206, and then the process of step S606 is executed.

In step S605, the CPU of the integration processing unit 200 outputs the inverted wide view angle rear video image to the display unit 300. Subsequently, the process of step S607 is executed.

In step S606, the CPU of the integration processing unit 200 outputs the front image to the display unit 300. Subsequently, the process of step S607 is executed.

In step S607, the CPU of the integrated processing unit 200 determines whether or not there is an end request from the user. When the determination result is “NO”, the process proceeds to step S601, and when the determination result is “YES”, the process ends.

As explained above, according to the first embodiment, the rear video image is not inverted while the changeover signal is High by controlling the inversion/non-inversion of the rear video image based on the input of the changeover signal, and the correlation between the front video image and the rear video image can be maintained.

Additionally, the non-inverted rear video image is displayed when the front image is displayed by changing over between the case in which the front video image is displayed and the case in which the front video image is not displayed in conjunction with the inversion/non-inversion operation of the rear image based on the input of the changeover signals. Additionally, when the front video image is not displayed, the inverted rear video image can be displayed.

Additionally, it is possible to perform the display such that the correlation between the front video image and the rear video image can be visually recognized by the user can when the front video image is displayed by arranging two display regions such that the sides having a correlation between the front video image and the rear video image are displayed to face each other.

Additionally, for example, a portion of the rear bumper is cut out as an end portion on the rear side in the rear video image, such that, for example, a portion of the front bumper is cut out as an end portion on the front side in the front video image. Accordingly, the user can visually recognize both ends of the vehicle when the rear video image and the front video image are simultaneously displayed. Therefore, it is possible to easily identify the positional relation of the object in the front video image and the rear video image.

Thus, it is possible to realize an image processing system that switches between case in which the front video image is displayed and a case in which the front video image is not displayed are changed over and a display such that the user can grasp a correlation between the front video image and the rear video image is made when the front video image and the rear video image are simultaneously displayed.

### Second Embodiment

In the first embodiment, the rear video image display unit 311 and the second video image display unit 312 of the display unit 300 are arranged to be adjacent to each other in the horizontal direction. However, in the second embodiment, the rear video image display unit 311 and the second video image display unit 312 are arranged in the vertical direction.

That is, in the second embodiment, a method for displaying a front video image on a monitor having two display regions vertically adjacent to each other, and thereby the correlation between the front video image and the rear video image can be grasped will be described.

Note that, in the second embodiment, the right-side wide angle camera 110a and the left-side wide angle camera 110b are mounted on the vehicle in a manner such that the optical axes of the wide angle lenses 111a and 111b are substantially perpendicular to the ground. That is, when the rear display region and the second display region are arranged vertically, the optical axes of the optical system are arranged in the vertical direction.

FIG. 7 is a functional block diagram illustrating a configuration example of an image processing system 1000′ according to the second embodiment. In the image processing system 1000′, the integration processing unit 200 has a rotation unit 207 in addition to the configuration in FIG. 1.

The rotation unit 207 performs rotation of each of the rear video image, the front video image, and the wide view angle rear video image. For example, when each of the video images is each of video images that has been cut out from the video image data captured by the right-side wide angle camera 110a, the rotation unit 207 rotates each of the video images clockwise by 90°. In contrast, when each of the video images is each of video images that has been cut out from the video image data captured by the left-side wide angle camera 110b, the rotation unit 207 rotates each of the video images counterclockwise by 90°.

Note that, in the second embodiment, the inversion/non-inversion processing is performed on the rear video image by the inversion control unit 202, the inversion of the wide view angle rear video image is performed by the inversion unit 204, and then each video image is rotated by the rotation unit 207.

However, the inversion/non-inversion processing of the rear video image and the inversion of the wide view angle rear video image may be performed after the rotation of each image. In a case in which the inversion is performed after the rotation, the inversion direction of each of the rear video image and the wide view angle rear video image is the vertical inversion instead of the horizontal inversion.

By rotating the front video image as described above, the orientation of the front video image is matched to the top and bottom of the actual space when, for example, the user looks at the windshield from the driver's seat. In addition, by rotating the rear video image and the wide view angle rear video image at the same angle as the front image, the correlation with the front video image can be maintained.

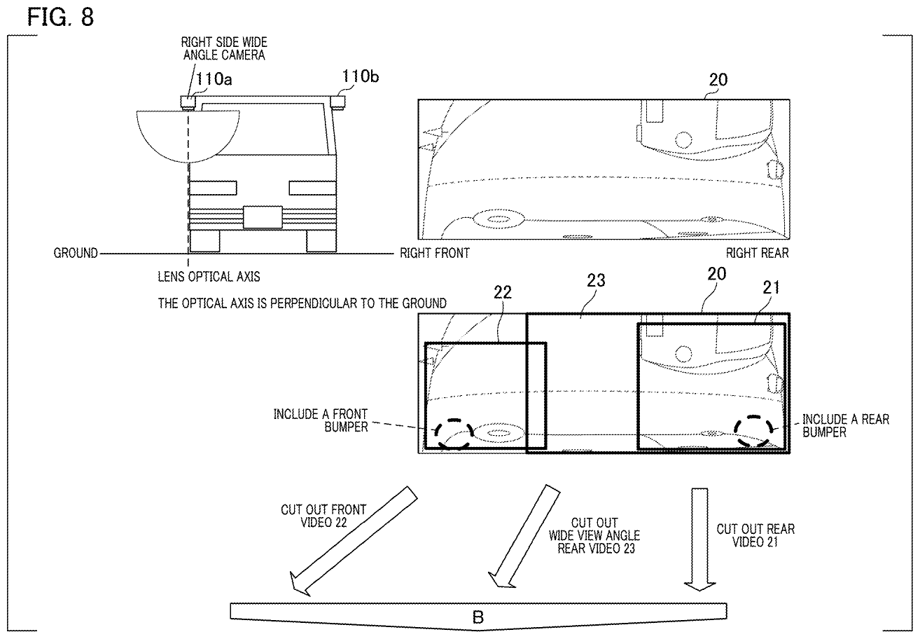

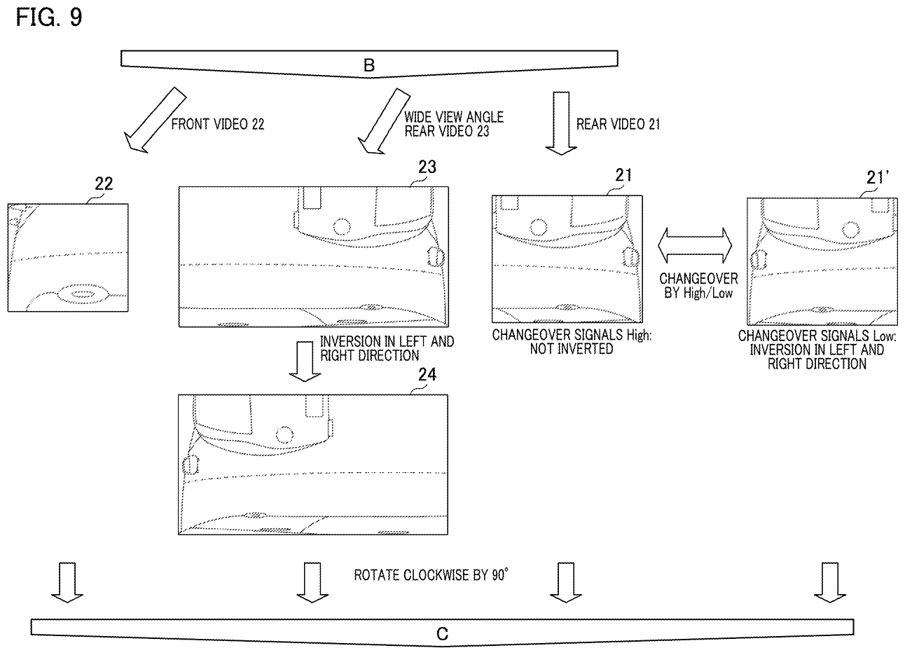

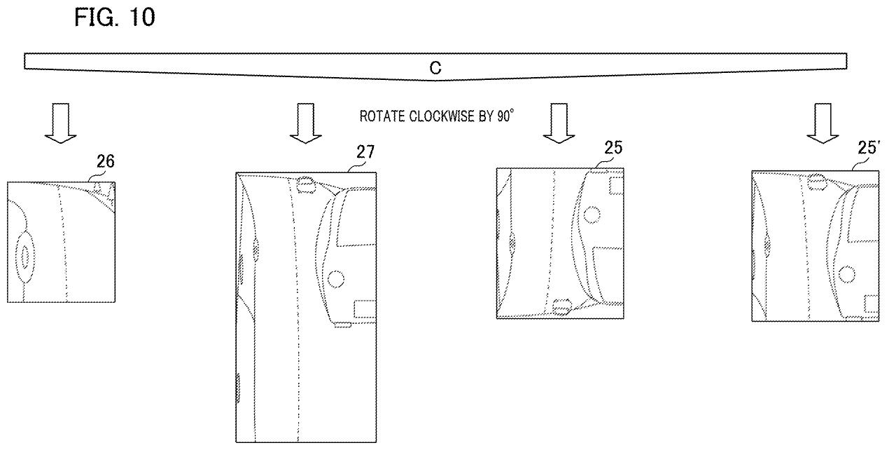

The overall operation of the integrated processing unit 200 in the second embodiment will be explained with reference to FIG. 8 to FIG. 10. FIG. 8 is a diagram for explaining an example of a video image formed in the second embodiment, FIG. 9 is a diagram for explaining a continuation of FIG. 8, and FIG. 10 is a diagram for explaining a continuation of FIG. 9.

In the operation explained with reference to FIG. 8 to FIG. 10, each of the video images 21, 21′, 22, and 24 is rotated clockwise by 90° as shown in FIG. 9 and FIG. 10, in addition to the explanation of FIG. 2 and FIG. 3. As a result, the rear video image 25 that is not inverted, a rear video image 25′ that is inverted in a right and left direction, a front video image 26, and a wide view angle rear video image 27 are respectively formed.

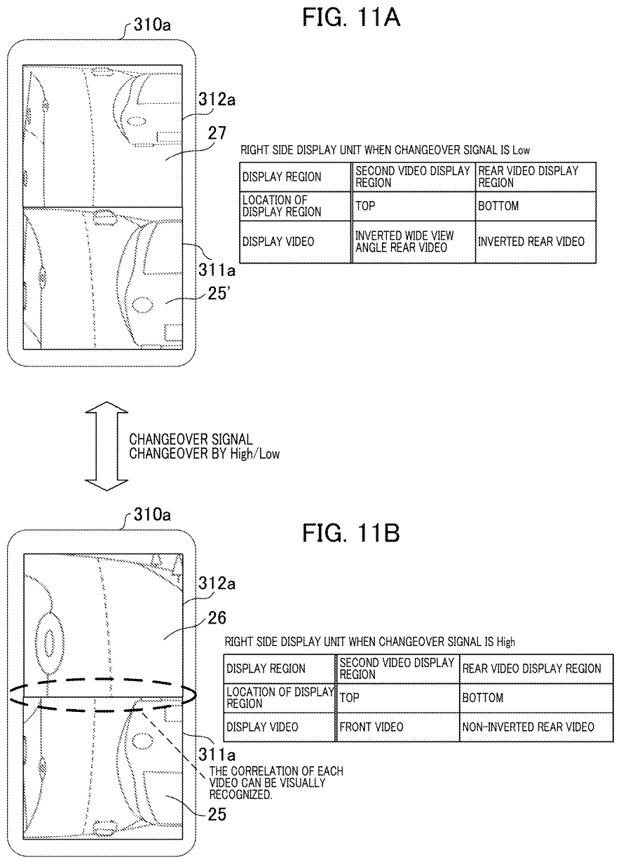

FIGS. 11A and 11B are diagrams for explaining a display example of the display unit 300 in the second embodiment, and, in particular, they show a display example in the right-side display unit 310a. The rear video image display unit 311a and the second video display unit 312a of the right-side display unit 310a are arranged so as to be adjacent to each other in the vertical direction as shown in FIG. 11A.

Note that, although not illustrated, the rear video display unit 311b and the second video display unit 312b of the left-side display unit 310b are similarly disposed so as to be adjacent to each other in the vertical direction.

Here, the rear video image display unit 311a is set such that the lower side of the display screen of the right-side display unit 310a is the rear video image display region, and the second video image display unit 312a is set such that the upper side of the display screen of the right-side display unit 310a is the second video image display region. Additionally, the rear video image display unit 311b is set such that the lower side of the display screen of the left-side display unit 310b is the rear video image display region, and the second video image display unit 312b is set such that the upper side of the display screen of the left-side display unit 310b is the second video image display region.

Additionally, as shown in FIG. 11A, when the changeover signal is Low, the wide view angle rear video image 27 and the rear video image 25′ that is inverted are simultaneously displayed in the right-side display unit 310a in the vertical direction. When the changeover signal is High, the front video image 26 and the rear video image 25 that is not inverted are simultaneously displayed in the vertical direction. Although not illustrated, the same applies to the left-side display unit 310b.

As described above, even in a case in which the two display regions of the monitor are vertically adjacent to each other, the sides having a correlation between the front video image and the rear video image are displayed to face each other, and thereby, the user can visually recognize the correlation between the front video image and the rear video image while the changeover signal is High.

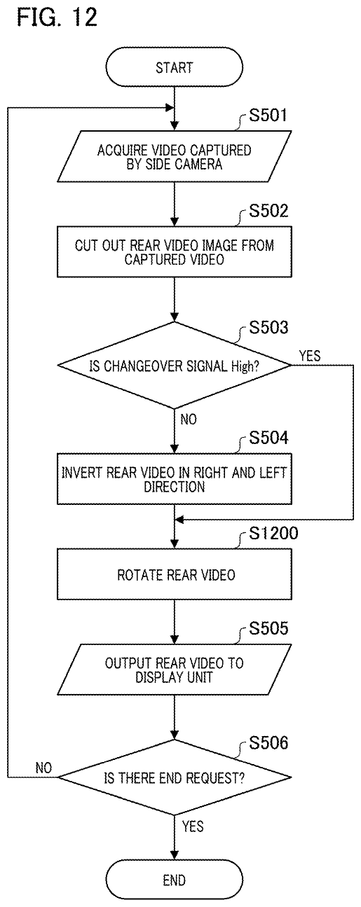

FIG. 12 is a flowchart for explaining an operation example in which the integration processing unit 200 outputs the rear video image to the display unit 300 in the second embodiment. The processes of the flowchart in FIG. 12 are sequentially performed by a computer program executed by a CPU (not illustrated) of the integration processing unit 200. Since step S501 to step S506 of FIG. 12 are similar to those of FIG. 5, the description thereof will be omitted or simplified.

In step S503, the CPU of the integrated processing unit 200 determines whether or not the changeover signal input from the changeover signal input unit 400 is High. When the determination result is “NO”, the process proceeds to step S504, and when the determination result is “YES”, the rear video image is input to the rear video output unit 203, and then the process of step S1200 is executed.

In step S504, the CUP of the integration processing unit 200 inverts the right and left of the rear video image. Subsequently, the inverted rear video image is input to the rotation unit 207. Subsequently, the process of step S1200 is executed.

In step S1200, the CPU of the integration processing unit 200 rotates the rear video image. At this time, the rear video image formed from the video image data of the right-side wide-angle camera 110a is rotated clockwise by 90°, and the rear video image formed by the video image data of the left-side wide angle camera 110b is rotated counterclockwise by 90°. Subsequently, the rotated rear video image is input to the rear video output unit 203, and the process of step S505 is executed.

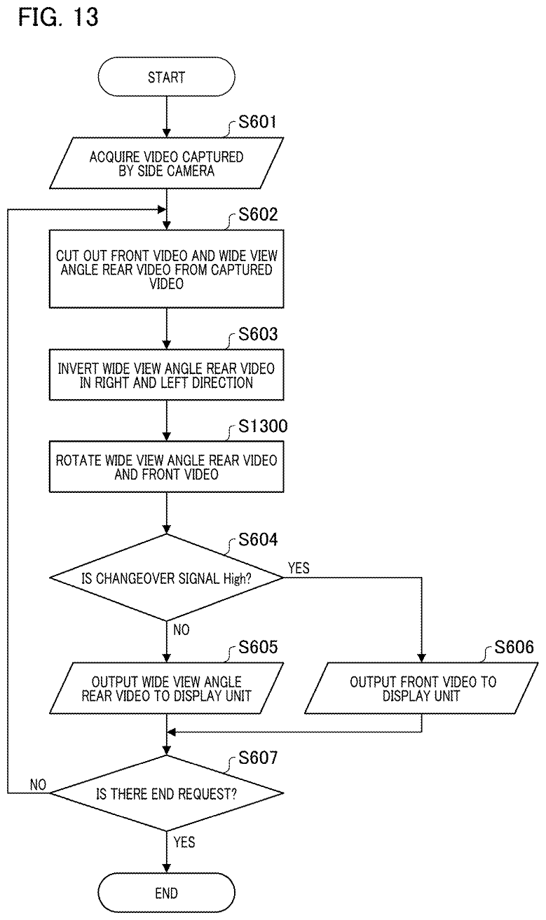

FIG. 13 is a flowchart for explaining an operation example in which the integration processing unit 200 outputs the second video image to the display unit 300 in the second embodiment. The processes of the flowchart in FIG. 12 are sequentially performed by a computer program executed by a CPU (not illustrated) of the integration processing unit 200. Steps S601 to S607 of FIG. 13 are similar processes as those in FIG. 6, and thus description thereof will be omitted or simplified.

In step S603, the CPU of the integration processing unit 200 inverts the right and left of the wide view angle rear video image 23. Subsequently, the wide view angle rear video image 24 that is inverted is input to the rotation unit 207. Subsequently, the process of step S1300 is executed.

In step S1300, the CPU of the integration processing unit 200 rotates the wide view angle rear video image 24 and the front video image 22. At this time, the wide view angle rear video image and the front video image formed from the video image data of the right-side wide angle camera 110a are rotated clockwise by 90°, and the wide view angle rear image and the front image formed from the video image data of the left-side wide angle camera 110b are rotated counterclockwise by 90°.

Subsequently, the rotated wide view angle rear video image 27 and the front image 26 are input to the input changeover unit 205, and then the process of step S604 is executed.

As described above, according to the second embodiment, the orientation of the front video image is matched to the top and bottom of the actual space viewed from the windshield by the user by rotating the front video image. Additionally, the correlation between the video images can be maintained even in the case in which the video images are rotated by rotating the rear video image and the wide view angle rear video image at the same angle as the front video image.

Thus, even in the case in which the two display regions of the monitor are vertically adjacent to each other, the front video image is rotated, and the rear video image is rotated so as to correspond to the front video image. As a result, when the front video image and the rear video image are displayed at the same time, a display such that a user can grasp the correlation between the video images can be performed.

### Third Embodiment

Although, in the first embodiment and the second embodiment, the configuration in which one of the front video image and the wide view angle rear video image is changed over and displayed in the second video display region, the information to be displayed when the front video image is not displayed in the second video display region is not limited to the wide view angle rear video image.

For example, a configuration may be used in which the omnidirectional image formed by combining the video image data captured by the right-side wide angle camera 110a, the left-side wide angle camera 110b, the front camera 120, and the rear camera 130 is displayed in the second image display region.

FIG. 14 is a functional block diagram illustrating a configuration example of an image processing system in the third embodiment. In an image processing system 1000″, the image capture unit 100 has a front camera 120 and a rear camera 130 in addition to the configurations of FIG. 1 and FIG. 7. Additionally, the integration processing unit 200 has an omnidirectional video image forming unit 208.

The front camera 120 is attached to, for example, a front bumper of the vehicle, and captures an image of the front of the vehicle. The rear camera 130 is attached to, for example, a rear bumper of the vehicle, and captures an image of the rear of the vehicle.

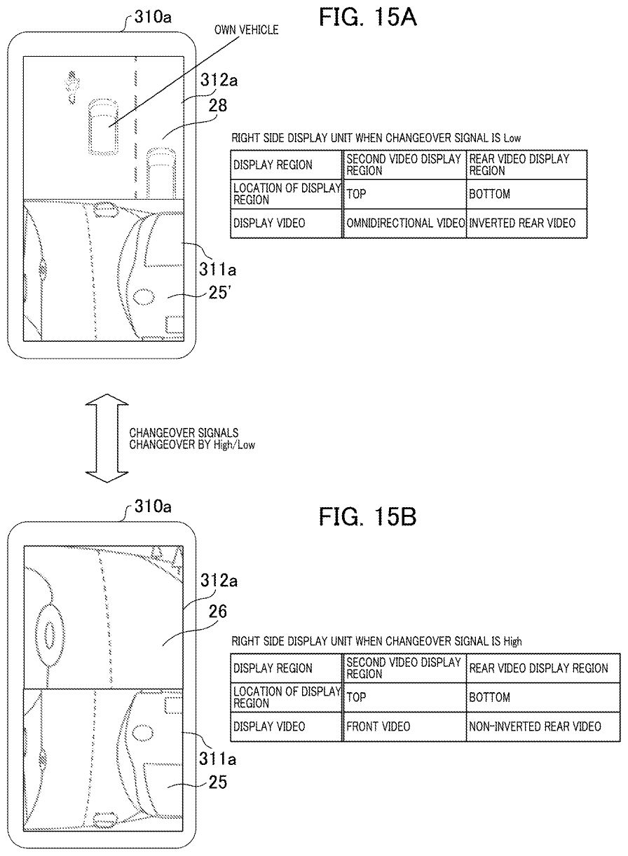

The omnidirectional video image forming unit 208 converts video images of the surroundings of the vehicle captured by a plurality of cameras into video images viewed from directly above, and combines the video images to form a 360° bird's-eye view video image (omnidirectional video image) centered on the vehicle. For example, the omnidirectional image 28 as shown in FIG. 15A may be formed by combining the video image data in each of directions obtained by the right-side wide angle camera 110a, the left-side wide angle camera 110b, the front camera 120, and the rear camera 130 and superimposing the images of the vehicle.

FIGS. 15A and 15B are diagrams for explaining a display example of the display unit 300 in the third embodiment, and show, in particular, the right-side display unit 310a.

Although, in the third embodiment, the configuration in which the omnidirectional image 28 is displayed in the second image display region is used, note that the video image displayed in the second image display region may be a 180° bird's-eye view video image on the right side of the vehicle or may be a 180° bird's-eye view video image on the left side of the vehicle. In addition, a variety of information indicating the state of the vehicle, such as the state of the shift lever, the vehicle speed, the remaining amount of gasoline, the state of a blinker, and the presence or absence of a seat belt, may be detected, and the variety of information may be displayed in the second image display region.

As described above, when the front image is not displayed, arbitrary information can be displayed in the second image display region.

### Fourth Embodiment

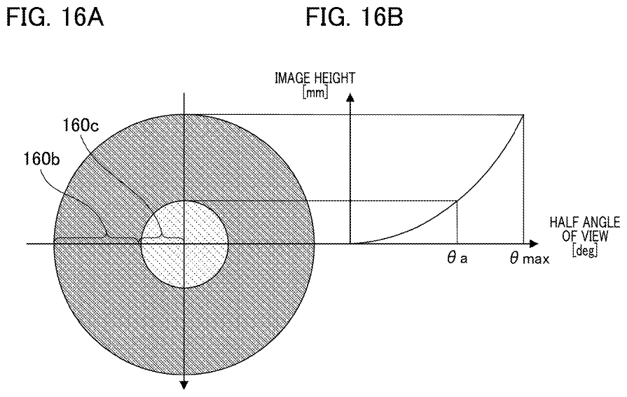

In the fourth embodiment, the resolutions at the periphery of the angle of view of the optical system are set to be relatively higher than those at the center of the angle of view. FIGS. 16A and 16B are diagrams for explaining the optical characteristics of the wide-angle lenses 111a and 111b serving as the optical systems according to the fourth embodiment. FIG. 16A is a diagram showing the image height y at each of half angles of view on the light receiving surface of the image sensing element of the optical system in the fourth embodiment in the form of contour lines.

FIG. 16B is a diagram showing projection characteristics representing a relation between the image height y and a half angle of view θ of the optical system in the fourth embodiment. In FIG. 16B, a horizontal axis represents a half angle of view (an angle formed by an optical axis and an incident light beam) θ, and a vertical axis represents an imaging height (image height) y on a light receiving surface (image surface) of the image sensing elements 112a and 112b.

As shown in FIG. 16B, the optical system in the fourth embodiment is configured such that the projection characteristic y (θ) is different between a region smaller than a predetermined half angle of view θa and a region equal to or larger than the half angle of view θa. Accordingly, in the case in which the increase amount of the image height y to the half angle of view θ per unit is defined as a resolution, the resolution varies depending on the region.

It can also be said that this local resolution is represented by a differential value dy (θ)/d θ of the projection characteristic y (θ) at the half angle of view θ. That is, it can be said that the resolution is higher as the inclination of the projection characteristic y (θ) in FIG. 16B is larger. Additionally, it can also be said that the resolution is higher as the interval of the image height y in each half angle of view of the contour line of FIG. 16A is larger.

In the fourth embodiment, a central region formed on the light receiving surface when the half angle of view θ is less than a predetermined half angle of view θa is referred to as a low-resolution region 160c, and an outer region formed when the half angle of view θ is equal to or greater than the predetermined half angle of view θa is referred to as a high-resolution region 160b.

Note that the optical system in the fourth embodiment has a projection characteristic y (θ) satisfying the condition of Formula 1 below. That is, when the focal length of the optical system is f, the half angle of view is θ, the image height on the image plane is y, the projection characteristic representing the relation between the image height y and the half angle of view θ is y (θ), and θ max is the maximum half angle of view of the optical system, Formula 1 below is satisfied.

$$0.1 < 2 \times f \times tan ( θ max / 2 ) / y ( θ max ) < 1.2 \qquad [ Formula 1 ]$$

More preferably, Formula 2 below is satisfied.

$$0.2 < 2 \times f \times tan ( θ max / 2 ) / y ( θ max ) < 0.92 \qquad [ Formula 2 ]$$

Although the position at which the light-receiving surface of the image sensor element and the optical axis of the optical system intersect may substantially coincide with the center of the light-receiving surface, the position at which the light-receiving surface of the image sensor element and the optical axis of the optical system intersect may be shifted from the center of the light-receiving surface. In this case, it is desirable that 0<Lshift/Ls1<0.5 is set, where Ls1 is the width of the light-receiving surface and Lshift is the amount of shift.

It is possible to capture an image of the side of the vehicle with an angle of view of approximately 180° and to relatively increase the resolutions of an object in the front direction and the backward direction by using the optical system having the characteristics as in the fourth embodiment, and thereby, the visibility can be improved. Further, in the case of image recognition of an object in the forward direction and the backward direction, the image recognition accuracy can be improved.

Note that in the first embodiment to the fourth embodiment, the front video image and the rear video image are cut out from the video image data by using the video image of the side of the vehicle captured by the left wide view angle camera or the right wide view angle camera. However, a configuration may be used in which a front side camera and a rear side camera of the vehicle may respectively be mounted, and video image data of the front side camera may be set as the front video image and video image data of the rear side camera may be set as the rear video image.

Note that the movable apparatus in the above-described embodiment is not limited to vehicles such as an automobile, and may be any movable apparatus including a ship, an airplane, a robot, and a drone.

Additionally, in the first embodiment to the fourth embodiment, the image processing system is mounted on a vehicle serving as a movable apparatus, and has an image capturing unit for generating video image data. However, for example, the integration processing unit 200 and the display unit 300 may be provided in an external terminal that is disposed in a place separated from the movable apparatus, and the movable apparatus may be remotely controlled using the external terminal from a separated place.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the image processing system through a network or various storage media. Then, a computer (or a CPU, an MPU, or the like) of the image processing system may be configured to read and execute the program. In such a case, the program and the storage medium storing the program configure the present invention.

Additionally, the present invention includes an implementation using, for example, at least one processor or circuit configured to function of the embodiments explained above. Note that a plurality of processors may be used for distributed processing. Note that distributed processing may be performed using a plurality of processors.

What is claimed is:

1. An image processing system comprising:
at least one processor or circuit configured to function as:
an image acquisition unit configured to acquire video image data of a front video image captured in front of a movable apparatus and a rear video image captured in rear of the movable apparatus; and
a display unit configured to display a video image on a right side or a left side of the movable apparatus,
wherein the display unit displays the rear video image in a rear display region and displays second information in a second display region, and
wherein, in a case in which the front video image is displayed in the second display region, the rear video image is displayed in the rear display region without inverting the rear video image, and in a case in which the front video image is not displayed in the second display region, the rear video image is inverted and displayed in the rear display region.

2. The image processing system according to claim 1, wherein the rear display region and the second display region of the display unit are arranged side by side vertically or horizontally.

3. The image processing system according to claim 1, wherein the rear display region and the second display region of the display unit are arranged in a manner such that the sides having a correlation between the front video image and the rear video image are adjacent to each other during display of the front video image in the second display region.

4. The image processing system according to claim 1, wherein the image acquisition unit acquires the video image data from an image capture unit that captures a wide-angle video image by an optical system capable of capturing an image from a front to a rear of a side surface of a movable apparatus, and
wherein the front video image and the rear video image are cut out from the video image data.

5. The image processing system according to claim 4, wherein the optical system has an optical characteristic in which a resolution of a peripheral portion of an angle of view is relatively higher than that of a central portion of the angle of view.

6. The image processing system according to claim 5, wherein, when f is a focus length of the optical system, θ is a half angle of view, y is an image height on an image plane, y (θ) is a projection characteristic representing a relation between the image height y and the half angle of view θ, and θmax is a maximum half angle of view of the optical system, 0.1<2×f×tan (θmax/2)/y(θmax)<1.2 is satisfied.

7. The image processing system according to claim 4, wherein, in a case in which the rear display region and the second display region of the display unit are arranged horizontally, an optical axis of the optical system is arranged in a horizontal direction.

8. The image processing system according to claim 4, wherein, in a case in which the rear display region and the second display region of the display unit are arranged vertically, an optical axis of the optical system is arranged in a vertical direction.

9. The image processing system according to claim 4, wherein, in a case in which the front video image is cut out from the video image data, the video image acquisition unit cuts out the front video image so as to include an end portion on the front side of the movable apparatus, and in a case in which the rear video image is cut out from the video image data, the image acquisition unit cuts out the rear video image so as to include an end portion on the rear side of the movable apparatus.

10. A movable apparatus comprising:
at least one processor or circuit configured to function as:
an image acquisition unit configured to acquire video image data of a front video image captured in front of a movable apparatus and a rear video image captured in rear of the movable apparatus; and
a display unit configured to display a video image on a right side or a left side of the movable apparatus,
wherein the display unit displays the rear video image in a rear display region and displays second information in a second display region, and
wherein, in a case in which the front video image is displayed in the second display region, the rear video image is displayed in the rear display region without inverting the rear video image, and in a case in which the front video image is not displayed in the second display region, the rear video image is inverted and displayed in the rear display region; and
a video image unit for generating the video image data.

11. An image processing method comprising:
acquiring video image data of a front video image captured in front of a movable apparatus and a rear video image captured in rear of the movable apparatus; and
displaying a video image on a right side or a left side of the movable apparatus,
wherein the displaying includes displaying the rear video image in a rear display region and displaying second information in a second display region, and wherein, in a case in which the front video image is displayed in the second display region, the rear video image is displayed in the rear display region without inverting the rear video image, and, in a case in which the front video image is not displayed in the second display region, the rear video image is inverted and displayed in the rear display region.

12. A non-transitory computer-readable storage medium configured to store a computer program comprising instructions for executing the following processes:
acquiring video image data of a front video image captured in front of a movable apparatus and a rear video image captured in rear of the movable apparatus; and
displaying a video image on a right side or a left side of the movable apparatus,
wherein the displaying includes displaying the rear video image in a rear display region and displaying second information in a second display region, and wherein, in a case in which the front video image is displayed in the second display region, the rear video image is displayed in the rear display region without inverting the rear video image, and, in a case in which the front video image is not displayed in the second display region, the rear video image is inverted and displayed in the rear display region.
